(19) United States
(12) Patent Application Publication
(10) Pub. No.: US 2024/0231946 A9
(43) Pub. Date: Jul. 11, 2024

(54) PROCESS ALLOCATION CONTROL DEVICE, PROCESS ALLOCATION CONTROL METHOD, AND RECORDING MEDIUM STORING PROCESS ALLOCATION CONTROL PROGRAM

(71) Applicant: NEC Corporation, Minato-ku, Tokyo (JP)

(72) Inventors: Yumiko Urasawa, Tokyo (JP); Takahiro Kawazu, Tokyo (JP); Yoshikazu Watanabe, Tokyo (JP)

(73) Assignee: NEC Corporation, Minato-ku, Tokyo (JP)

(21) Appl. No.: 18/269,183

(22) PCT Filed: Nov. 8, 2021
(86) PCT No.: PCT/JP2021/040905

§ 371 Date: Jun. 22, 2023

(30) Foreign Application Priority Data
Dec. 25, 2020 (JP) 2020-216116

(51) Int. Cl. G06F 9/50

(52) U.S. Cl. CPC G06F 9/5066

(57) ABSTRACT

A process allocation control device achieves efficient control of satisfactorily utilizing an accelerator included in an information processing device by including: a reception unit that receives a request to execute a process, which can be executed by a plurality of processors having different configurations and has different characteristics of performance exhibited through execution by the different processors; a detection unit that detects the states of the plurality of processors; and an allocation unit that allocates execution of the process to at least one of the plurality of processors on the basis of the states of the plurality of processors and the characteristics of the process.

### TECHNICAL FIELD

The present invention relates to a process allocation control device, a process allocation control method, and a process allocation control program.

### BACKGROUND ART

Recently, speed-up of information processing by providing an accelerator, such as a graphics processing unit (GPU) or a co-processor has been performed in various systems. Such an accelerator has attracted attention not only as a device used for high-performance calculation but also as a device for speeding up machine learning or processing of a large amount of data. A technique for achieving improvement in processing performance of the entire system by effectively utilizing such an accelerator as much as possible has been expected.

As a technique related to such a technique, PTL 1 discloses a method for controlling a heterogeneous multiprocessor system including a plurality of processor elements having different instruction sets and configurations. In this method, an executable task is extracted based on a preset depending relationship of a plurality of tasks. In this method, a plurality of first processors is allocated to a general-purpose processor group, and a second processor is allocated to an accelerator group based on a depending relationship among the extracted tasks. In this method, a task to be allocated is determined from the extracted tasks based on a preset priority value for each task, and an execution cost when the determined task is executed by the first processor is compared with an execution cost when the task is executed by the second processor. Then, in this method, the task is allocated to one of the general-purpose processor group and the accelerator group having the lower execution cost as a result of the comparison.

In addition, PTL 2 discloses a method for dynamically managing accelerator resources. In this method, a first set of hardware accelerator resources is initially allocated to a first information processing system, and a second set of hardware accelerator resources is initially allocated to a second information processing system. In this method, jobs running on the first and second information processing systems are monitored. In this method, when one of the jobs fails to satisfy a goal, at least one hardware accelerator resource in the second set of hardware accelerator resources is dynamically reallocated from the second information processing system to the first information processing system.

### CITATION LIST

### Patent Literature

PTL 1: JP 2007-328415 A
PTL 2: JP 2013-515991 A

### SUMMARY OF INVENTION

### Technical Problem

In a system including a plurality of types of processors having different configurations as accelerators, performance of information processing of the system can be improved by performing control to satisfactorily utilize the accelerators. For example, in the method according to PTL 1 described above, the control to satisfactorily utilize the accelerators is performed by calculating execution costs (processing times) of a certain process (task) by the processors and allocating execution of the process to a processor having the lowest execution cost.

In the method according to PTL 1, however, there is overhead of performing processing of calculating the execution cost of each of the processors when execution of a task is allocated to a certain processor, and there is a problem that the performance of information processing of the system is deteriorated accordingly. That is, a problem is to achieve efficient control of satisfactorily utilizing an accelerator included in an information processing device. PTL 2 described above also does not particularly mention this problem.

A main object of the present invention is to provide a process allocation control device and the like achieving efficient control of satisfactorily utilizing an accelerator included in an information processing device.

### Solution to Problem

A process allocation control device according to an aspect of the present invention includes: a reception means for receiving a request to execute a process that can be executed by a plurality of processors having different configurations and has different characteristics of performance exhibited through execution by the different processors; a detection means for detecting states of the plurality of processors; and an allocation means for allocating execution of the process to at least one of the plurality of processors based on the states of the plurality of processors and the characteristics of the process.

From another viewpoint of achieving the above object, a process allocation control method according to an aspect of the present invention includes: receiving, by an information processing device, a request to execute a process that is executable by a plurality of processors having different configurations and has different characteristics of execution performance exhibited by the different processors; detecting, by the information processing device, states of the plurality of processors; and allocating, by the information processing device, execution of the process to at least one of the plurality of processors based on the states of the plurality of processors and the characteristics of the process.

From an additional viewpoint of achieving the above object, a process allocation control program according to an aspect of the present invention causes a computer to execute: a reception process of receiving a request to execute a process that is executable by a plurality of processors having different configurations and has different characteristics of execution performance exhibited by the different processors; a detection process of detecting states of the plurality of processors; and an allocation means process of allocating execution of the process to at least one of the plurality of processors based on the states of the plurality of processors and the characteristics of the process.

Furthermore, the present invention can also be achieved by a computer-readable non-volatile recording medium storing the process allocation control program (computer program).

### Advantageous Effects of Invention

According to the present invention, it is possible to obtain the process allocation control device and the like achieving the efficient control of satisfactorily utilizing an accelerator included in the information processing device.

### BRIEF DESCRIPTION OF DRAWINGS

FIG. 1 is a block diagram illustrating a configuration of a process allocation control device 10 according to a first example embodiment of the present invention.

FIG. 2A is a flowchart (1/2) illustrating the operation of the process allocation control device 10 according to the first example embodiment of the present invention.

FIG. 2B is a flowchart (2/2) illustrating the operation of the process allocation control device 10 according to the first example embodiment of the present invention.

FIG. 3 is a block diagram illustrating a configuration of a process allocation control device 20 according to a second example embodiment of the present invention.

FIG. 4 is a block diagram illustrating a configuration of an information processing device 900 capable of achieving a process allocation control device according to each example embodiment of the present invention.

### EXAMPLE EMBODIMENT

Hereinafter, example embodiments of the present invention will be described in detail with reference to the drawings.

### First Example Embodiment

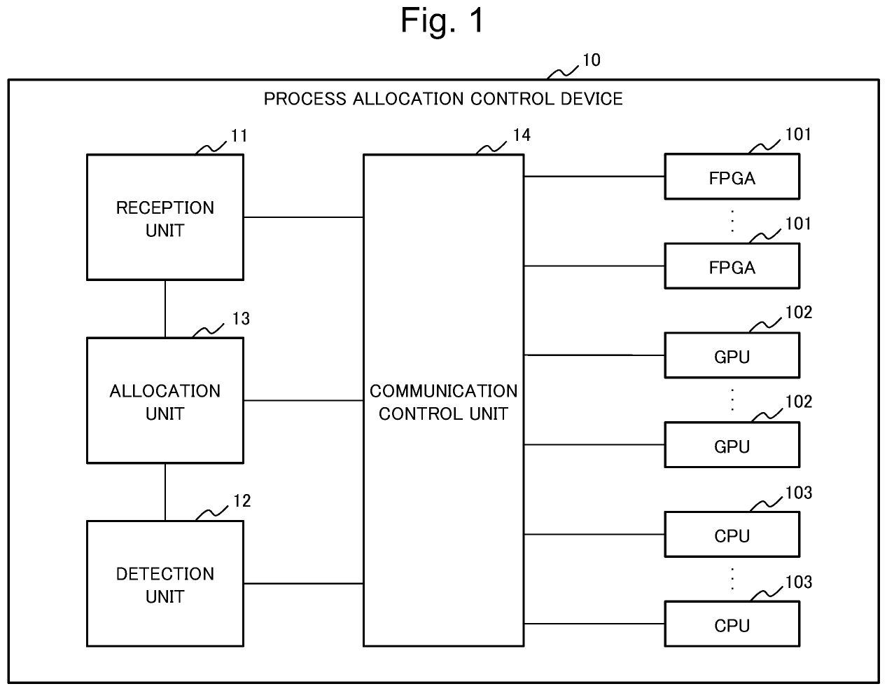

FIG. 1 is a block diagram illustrating a configuration of a process allocation control device 10 according to a first example embodiment of the present invention. The process allocation control device 10 is an information processing device that includes one or more field programmable gate arrays (FPGAs) 101 and one or more GPUs 102 as accelerators (also referred to as co-processors) in addition to one or more central processing units (CPUs) 103 as a processor that executes information processing. Note that accelerators included in the process allocation control device 10 are not limited to the FPGA 101 and the GPU 102. That is, the process allocation control device 10 may include, as an accelerator, a processor of a different type from the FPGA 101 and the GPU 102, such as a vector arithmetic processor.

The CPU 103 has a function of executing a user application and entrusting (offloading) execution of a process including specific computation processing included in the user application to the FPGA 101 or the GPU 102.

The GPU 102 is a processor configured using predetermined hardware capable of executing a specific type of information processing (computation) at a high speed. The specific type of information processing is, for example, image processing (image recognition), fingerprint matching, machine learning, or the like.

The FPGA 101 is a processor that is capable of executing a specific type of information processing at a high speed and allows a user to change a logic circuit. In the FPGA 101, for example, the logic circuit is formed so that the user application can be executed at a high speed based on a characteristic of the computation included in the user application.

It is assumed that the FPGA 101, the GPU 102, and the CPU 103 according to the present example embodiment are processors having different configurations, such as instruction sets, and having characteristics that types of information processing executable at a high speed are different from each other. In addition, it is assumed that the FPGA 101, the GPU 102, and the CPU 103 can execute the same process by using a technique that can conceal a difference in the configuration between the processors in the execution of the process. The technique that can conceal the difference in the configuration between the processors is, for example, a function of converting an instruction code included in a process executed by the FPGA 101, the GPU 102, and the CPU 103 into an instruction code executable by the own processor. For example, the FPGA 101 may incorporate a logic circuit for converting and executing an instruction code for the GPU 102.

The process allocation control device 10 includes a reception unit 11, a detection unit 12, an allocation unit 13, and a communication control unit 14 in addition to the FPGA 101, the GPU 102, and the CPU 103. The reception unit 11, the detection unit 12, and the allocation unit 13 are an example of a reception means, an allocation means, and a detection means in this order.

The communication control unit 14 controls communication related to information transmitted and received between each of the reception unit 11, the detection unit 12, and the allocation unit 13 and each of the FPGA 101, the GPU 102, and the CPU 103.

The reception unit 11 receives a request to execute a process assigned with an execution priority from the CPU 103, for example. The execution priority is assigned by, for example, an operating system (OS) that controls execution of the process. As described above, the process is a process that can be executed by the FPGA 101, the GPU 102, and the CPU 103 and has different characteristics of performance exhibited through execution by the different processors

The detection unit 12 has a function of detecting individual states of the FPGA 101, the GPU 102, and the CPU 103 as needed, and detects a state of load of each of these processors. The detection unit 12 detects the state of the load by acquiring a length of an execution queue of each of the FPGA 101, the GPU 102, and the CPU 103, for example. Meanwhile, the length of the execution queue represents the number of processes in execution standby states in each of the FPGA 101, the GPU 102, and the CPU 103. The execution queue may be provided for each processor or may be provided for each processor type (for example, collectively for a plurality of FPGAs 101).

The allocation unit 13 allocates execution of the process to at least one of the FPGA 101, the GPU 102, and the CPU 103 based on the state of the load (also referred to as the load state) of each of the processors detected by the detection unit 12 and the characteristic of the process received by the reception unit 11. However, the characteristic of the process represents a level of the execution performance of the process for each processor type depending on a configuration of the process and a configuration of each of the processors. It is assumed that information indicating the characteristics of this process is given in advance to the process allocation control device 10 by the user, for example, based on a configuration of the user application including the process and the configuration of each of the processors.

The allocation unit 13 has a function of allocating the execution of the process in descending order from a processor having highest execution performance of the process. The allocation unit 13 also has a function of allocating the execution of the process in ascending order from a processor having lowest load indicated by the load state.

Here, a specific example of the operation of the allocation unit 13 in a case where the execution performance indicated by the characteristics of the process received by the reception unit 11 increases in order of the FPGA 101, the GPU 102, and the CPU 103 will be described. That is, in this case, the FPGA 101 can execute the process at the highest speed from a relationship between the configuration of the process and the configuration of each of the processors, and an execution speed of the process decreases in order of the GPU 102 and the CPU 103.

In this case, the allocation unit 13 first determines whether execution of the process can be allocated to the FPGA 101 based on a predetermined criterion. More specifically, the allocation unit 13 uses, as the predetermined criterion, whether the length of the execution queue of the FPGA 101 is equal to or less than a threshold A. When the length of the execution queue of the FPGA 101 is equal to or less than the threshold A, the allocation unit 13 determines that the FPGA 101 is in a low load state and the execution of the process can be allocated to the FPGA 101, and allocates the execution of the process to at least one of the FPGAs 101.

When the length of the execution queue of the FPGA 101 is more than the threshold A, the allocation unit 13 determines that the FPGA 101 is in a high load state and it is difficult to allocate the execution of the process to the FPGA 101. In this case, the allocation unit 13 allocates the execution of the process to the GPU 102 or the CPU 103 as will be described later.

The allocation unit 13 sets the threshold A described above, for example, based on execution priorities of processes. More specifically, the allocation unit 13 sets the threshold A to be higher for a process having a higher execution priority. That is, the allocation unit 13 sets a criterion for determining that the execution of the process can be allocated to be lower for a process having a higher execution priority. The reason thereof is to facilitate allocation of the execution of the process having the higher execution priority to the FPGA 101 having the higher execution performance of the process.

When the length of the execution queue of the FPGA 101 is more than the threshold A, the allocation unit 13 determines whether the length of the execution queue of the GPU 102 is equal to or less than a threshold B in order to determine whether the execution of the process can be allocated to the GPU 102. When the length of the execution queue of the GPU 102 is equal to or less than the threshold B, the allocation unit 13 determines that the GPU 102 is in the low load state and the execution of the process can be allocated to the GPU 102, and allocates the execution of the process to at least one of the GPUs 102.

When the length of the execution queue of the GPU 102 is more than the threshold B, the allocation unit 13 determines that the GPU 102 is in the high load state and it is difficult to allocate the execution of the process to the GPU 102. In this case, the allocation unit 13 allocates the execution of the process to at least one of the CPUs 103.

The allocation unit 13 sets the threshold B based on, for example, execution priorities of processes similarly to the threshold A. More specifically, the allocation unit 13 sets the threshold B to be higher for a process having a higher execution priority. The reason thereof is to facilitate allocation of the execution of the process having the higher execution priority to the GPU 102 having higher execution performance than the CPU 103.

In a case where the level of the execution performance indicated by the process characteristic received by the reception unit 11 is, for example, the order of the GPU 102, the FPGA 101, and the CPU 103, the allocation unit 13 determines whether the execution of the process can be allocated in order of the GPU 102 and the FPGA 101 contrary to the above-described example.

For example, in a case where both the FPGA 101 and the GPU 102 are in the low load state and the execution of the process can be allocated to both the processors, the allocation unit 13 may allocate the execution of the process to both the processors.

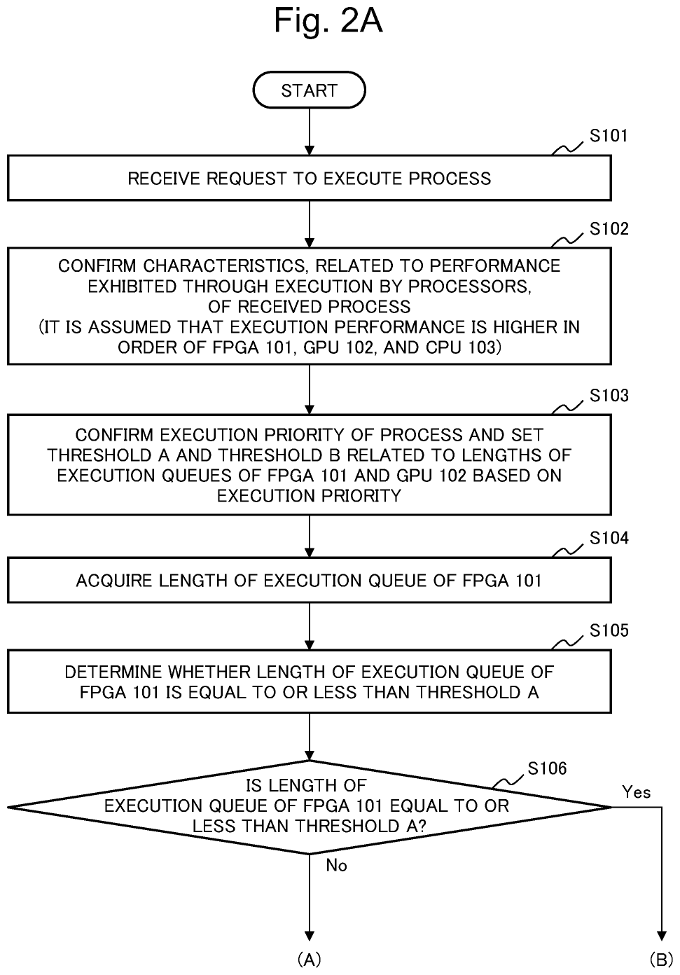

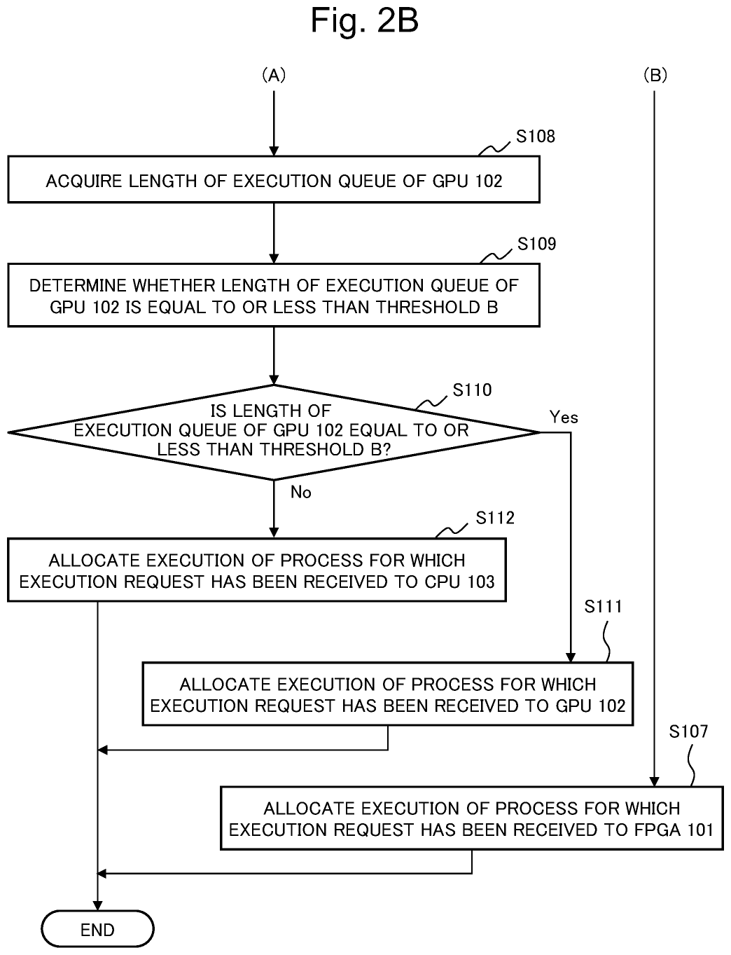

Next, the operation (processing) of the process allocation control device 10 according to the present example embodiment will be described in detail with reference to a flowchart of FIGS. 2A and 2B.

The reception unit 11 receives a request to execute a process from the CPU 103 (step S101). The allocation unit 13 confirms characteristics of the received process related to execution performance exhibited by the processors. Meanwhile it is assumed that the execution performance related to the process increases in order of the FPGA 101, the GPU 102, and the CPU 103 in this flowchart (step S102).

The allocation unit 13 confirms an execution priority of the process, and sets the threshold A and the threshold B related to the lengths of the execution queues of the FPGA 101 and the GPU 102 based on the execution priority (step S103). The detection unit 12 acquires the length of the execution queue of the FPGA 101 (step S104). The allocation unit 13 determines whether the length of the execution queue of the FPGA 101 is equal to or less than the threshold A (step S105).

When the length of the execution queue of the FPGA 101 is equal to or less than the threshold A (Yes in step S106), the allocation unit 13 allocates the execution of the process for which the execution request has been received by the reception unit 11 to at least one of the FPGAs 101 (step S107), and the entire processing ends.

When the length of the execution queue of the FPGA 101 is not equal to or less than the threshold A (that is, more than the threshold A) (No in step S106), the detection unit 12 acquires the length of the execution queue of the GPU 102 (step S108). The allocation unit 13 determines whether the length of the execution queue of the GPU 102 is equal to or less than the threshold B (step S109).

When the length of the execution queue of the GPU 102 is equal to or less than the threshold B (Yes in step S110), the allocation unit 13 allocates the execution of the process for which the execution request has been received by the reception unit 11 to at least one of the GPUs 102 (step S111), and the entire processing ends. When the length of the execution queue of the GPU 102 is not equal to or less than the threshold B (that is, more than the threshold B) (No in step S110), the allocation unit 13 allocates the execution of the process for which the execution request has been received by the reception unit 11 to at least one of the CPUs 103 (step S112), and the entire processing ends.

The process allocation control device 10 according to the present example embodiment can achieve efficient control of satisfactorily utilizing an accelerator included in the information processing device. This is because the process allocation control device 10 allocates the execution of the process to at least one processor based on the states of the processors and the characteristics of the process when receiving the request to execute the process having the different characteristics of the execution performance exhibited by the plurality of processors having the different configurations.

Hereinafter, effects achieved by the process allocation control device 10 according to the present example embodiment will be described in detail.

In a system including a plurality of types of processors having different configurations as accelerators, performance of information processing of the system can be improved by performing control to satisfactorily utilize the accelerators. For example, there is a method of performing control of satisfactorily utilizing an accelerator by calculating execution costs (processing times) of a certain process by processors and allocating execution of a task to a processor having the lowest execution cost. In such a method, however, there is overhead of performing processing of calculating the execution cost of each of the processors when execution of the process is allocated to a certain processor, and there is a problem that performance of information processing of a system is deteriorated accordingly. That is, a problem is to achieve efficient control of satisfactorily utilizing an accelerator included in an information processing device.

In order to solve such a problem, the process allocation control device 10 according to the present example embodiment includes the reception unit 11, the detection unit 12, and the allocation unit 13, and operates as described above with reference to FIGS. 1 to 2B, for example. That is, the reception unit 11 receives a request to execute a process that can be executed by the FPGA 101, the GPU 102, and the CPU 103, which are a plurality of processors having different configurations, and has different characteristics of execution performance exhibited by the different processors. The detection unit 12 detects states of the FPGA 101, the GPU 102, and the CPU 103. Then, the allocation unit 13 allocates the execution of the process to at least one of the FPGA 101, the GPU 102, and the CPU 103 based on the states of the FPGA 101, the GPU 102, and the CPU 103 and the characteristics of the process.

That is, the process allocation control device 10 according to the present example embodiment determines a processor to which execution of the process is to be allocated based on the states of the processors and the characteristics of the process known in advance without calculating an execution cost (processing time) of the process by each of the processors. In particular, the FPGA 101 includes the logic circuit constructed by the user, and thus, has a clear characteristic related to the execution performance depending on the relationship between the configuration of the processor and the configuration of the process. As a result, the process allocation control device 10 can achieve the efficient control of satisfactorily utilizing an accelerator included in the information processing device.

In addition, the process allocation control device 10 according to the present example embodiment receives requests to execute a plurality of processes having different execution priorities, and preferentially allocates a processor having higher execution performance for a process having a higher execution priority. More specifically, the process allocation control device 10 determines whether a state of the processor allows the allocation of the process based on a predetermined criterion in descending order from a processor having highest process execution performance, and sets the predetermined criterion to be lower as the execution priority of the process increases. As a result, the process allocation control device 10 can reliably achieve prompt execution of the process having the higher execution priority.

### Second Example Embodiment

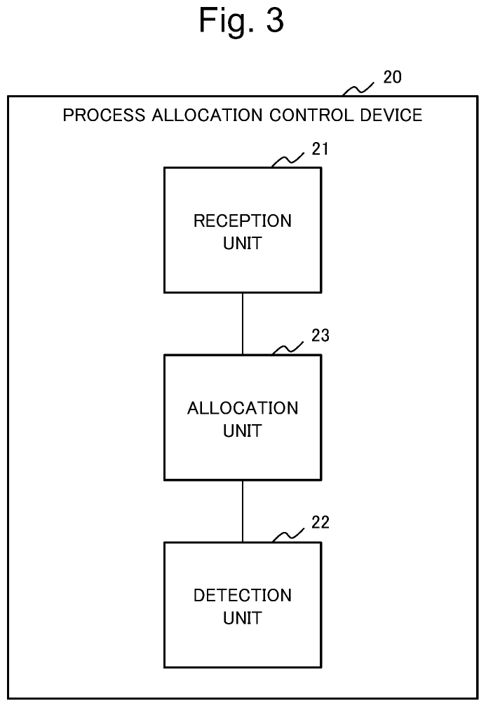

FIG. 3 is a block diagram illustrating a configuration of a process allocation control device 20 according to a second example embodiment of the present invention.

The process allocation control device 20 according to the present example embodiment includes a reception unit 21, a detection unit 22, and an allocation unit 23. The reception unit 21, the detection unit 22, and the allocation unit 23 are an example of a reception means, a detection means, and an allocation means in this order.

The reception unit 21 receives a request to execute a process that can be executed by a plurality of processors (not illustrated) having different configurations and has different characteristics of execution performance exhibited by the different processor. Each of the processors may be, for example, any of the processors such as the FPGA 101, the GPU 102, and the CPU 103 according to the first example embodiment. For example, the reception unit 21 operates similarly to the reception unit 11 according to the first example embodiment.

The detection unit 22 detects states of the plurality of processors. For example, the detection unit 22 may acquire a length of an execution queue indicating a load state of the processor similarly to the detection unit 12 according to the first example embodiment.

The allocation unit 23 allocates execution of the process to at least one of the plurality of processors based on the states of the plurality of processors and the characteristics of the process. For example, the allocation unit 23 may determine whether it is possible to allocate the execution of the process based on the load state in descending order from a processor having highest execution performance of the process similarly to the allocation unit 13 according to the first example embodiment.

The process allocation control device 20 according to the present example embodiment can achieve efficient control of satisfactorily utilizing an accelerator included in the information processing device. This is because the process allocation control device 20 allocates the execution of the process to at least one processor based on the states of the processors and the characteristics of the process when receiving the request to execute the process having the different characteristics of the execution performance exhibited by the plurality of processors having the different configurations.

<Example of Hardware Configuration>

Each of the units in the process allocation control devices illustrated in FIGS. 1 and 3 in the above-described example embodiments can be achieved by dedicated hardware (HW) (electronic circuit). In FIGS. 1 and 3, at least the following configurations can be regarded as functional (processing) units (software modules) of a software program including an instruction executed by a processor:
the reception units 11 and 21;
the detection units 12 and 22;
the allocation units 13 and 23; and
the communication control unit 14.

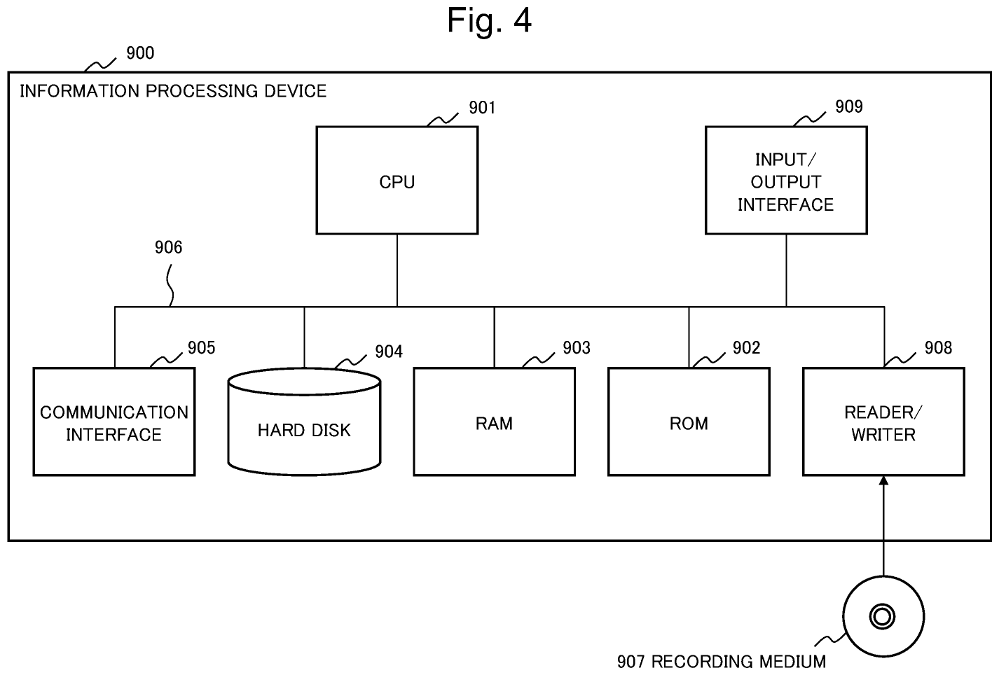

However, the division of each of the units illustrated in these drawings is configured for convenience of description, and various configurations can be assumed at the time of implementation. An example of a hardware environment in this case will be described with reference to FIG. 4.

FIG. 4 is a diagram for exemplarily describing a configuration of an information processing device 900 (computer) capable of achieving the process allocation control device according to each of the example embodiments of the present invention. That is, FIG. 4 represents the configuration of the computer (information processing device) capable of achieving the process allocation control devices illustrated in FIGS. 1 and 3, and the hardware environment capable of achieving each function in the example embodiments described above.

The information processing device 900 illustrated in FIG. 4 includes, as components, the following:
a central processing unit (CPU) 901;
a read only memory (ROM) 902;
a random access memory (RAM) 903;
a hard disk (storage device) 904;
a communication interface 905;
a bus 906 (communication line);
a reader/writer 908 capable of reading and writing data stored in a recording medium 907 such as a compact disc-read only memory (CD-ROM); and
an input/output interface 909 such as a monitor, a speaker, or a keyboard.

That is, the information processing device 900 including the above-described components is a general computer to which these configurations are connected via the bus 906. The information processing device 900 may include a plurality of the CPUs 901 or may include the CPU 901 configured by multiple cores. Although not illustrated in FIG. 4, the information processing device 900 sometimes include a processor (accelerator) such as the FPGA 101 or the GPU 102 illustrated in FIG. 1.

In the above-described example embodiments, a computer program capable of achieving the following functions may be supplied to the information processing device 900 illustrated in FIG. 4. For example, the functions are the above-described configurations in the block configuration diagrams (FIGS. 1 and 3) used as the references in the description of the example embodiments or the functions of the flowchart (FIGS. 2A and 2B). Thereafter, the functions of the process allocation control device according to the present example embodiments are achieved by the CPU 901 of the hardware reading, interpreting, and executing the computer program. The computer program supplied into the device may be stored in a readable/writable volatile memory (the RAM 903) or a nonvolatile storage device such as the ROM 902 or the hard disk 904.

In the above case, a general procedure can be adopted at present as a method for supplying the computer program into the hardware. Examples of the procedure include a method of installing the computer program in the device via the various recording media 907 such as a CD-ROM, a method of downloading the computer program from the outside via a communication line such as the Internet, and the like. In such a case, the computer program supplied to the information processing devices according to the present example embodiments can be regarded as being configured by a code constituting the program or the recording medium 907 storing the code.

The present invention has been described as above using the above-described example embodiments as exemplary examples. However, the present invention is not limited to the above-described example embodiments. That is, the present invention can apply various modes that can be understood by those skilled in the art within a scope of the present invention.

This application is based upon and claims the benefit of priority from Japanese patent application No. 2020-216116, filed on Dec. 25, 2020, the disclosure of which is incorporated herein in its entirety by reference.

### REFERENCE SIGNS LIST

10 process allocation control device
11 reception unit
12 detection unit
13 allocation unit
14 communication control unit
101 FPGA
102 GPU
103 CPU
20 process allocation control device
21 reception unit
22 detection unit
23 allocation unit
900 information processing device
901 CPU
902 ROM
903 RAM
904 hard disk (storage device)
905 communication interface
906 bus
907 recording medium
908 reader/writer
909 input/output interface

What is claimed is:

1. A process allocation control device comprising:
at least one memory storing a computer program; and
at least one processor configured to execute the computer program to
receive a request to execute a process that is executable by a plurality of processors having different configurations and has different characteristics of execution performance exhibited by the different processors;
detect states of the plurality of processors; and
allocate execution of the process to at least one of the plurality of processors based on the states of the plurality of processors and the characteristics of the process.

2. The process allocation control device according to claim 1, wherein the processor is configured to execute the computer program to
allocate the execution of the process in descending order from the processor having highest execution performance of the process.

3. The process allocation control device according to claim 1, wherein the processor is configured to execute the computer program to
detect load states of the plurality of processors, and
allocate the execution of the process in ascending order from the processor with lowest load indicated by the load state.

4. The process allocation control device according to claim 3, wherein the processor is configured to execute the computer program to
acquire a number of the processes in execution standby states in each of the plurality of processors.

5. The process allocation control device according to claim 1, wherein the processor is configured to execute the computer program to
receive requests to execute a plurality of the processes having different execution priorities, and
allocate the processor for the process such that the higher an increase of the execution priority of the process causes the execution performance of the process by the processor to increase.

6. The process allocation control device according to claim 5, wherein the processor is configured to execute the computer program to
determine whether a state of the processor allows allocation of the process based on a predetermined criterion in descending order from the processor having highest execution performance of the process, and set the predetermined criterion such that a lowering of the predetermined criterion causes the execution priority of the process to increase.

7. The process allocation control device according to claim 1, further comprising
the plurality of processors.

8. The process allocation control device according to claim 1, wherein
the plurality of processors are a field programmable gate array (FPGA), a graphics processing unit (GPU), and a central processing unit (CPU).

9. A process allocation control method, comprising:
receiving, by an information processing device, a request to execute a process that is executable by a plurality of processors having different configurations and has different characteristics of execution performance exhibited by the different processors;
detecting, by the information processing device, states of the plurality of processors; and
allocating, by the information processing device, execution of the process to at least one of the plurality of processors based on the states of the plurality of processors and the characteristics of the process.

10. A non-transitory computer-readable recording medium storing a process allocation control program for causing a computer to execute:
a reception process of receiving a request to execute a process that is executable by a plurality of processors having different configurations and has different characteristics of execution performance exhibited by the different processors;
a detection process of detecting states of the plurality of processors; and
an allocation process of allocating execution of the process to at least one of the plurality of processors based on the states of the plurality of processors and the characteristics of the process.
